(19) United States
(12) Patent Application Publication
(10) Pub. No.: US 2017/0052966 A1
(43) Pub. Date: Feb. 23, 2017

(54) TRANSLATING SEARCH ENGINE

(71) Applicant: Mobilearn Development Ltd., London (GB)

(72) Inventor: Claes PERSSON, Stockholm (SE)

(73) Assignee: Mobileam Development Ltd., Londong (DE)

(21) Appl. No.: 15/117,850

(22) PCT Filed: Feb. 11, 2015
(86) PCT No.: PCT/EP2015/052885

§ 371 Date: Aug. 10, 2016

(30) Foreign Application Priority Data
Feb. 11, 2014 (SE) 1450148-0

(51) Int. Cl. G06F 17/30; G06F 17/27; G06F 17/24; G06F 17/28

(52) U.S. Cl. CPC G06F 17/3087; G06F 17/30864; G06F 17/30669; G06F 17/30011; G06F 17/289; G06F 17/2795; G06F 17/2765; G06F 17/2705; G06F 17/24

(57) ABSTRACT

The invention relate to a computer implemented document retrieval method comprising the steps of: a) allowing a user to input a search term in a first language, b) applying a phonetic algorithm to the search term, so that a phonetic version of the search term is obtained, c) using the output from step b) to perform a search in a plurality of electronic documents in the first language where said search identifies the most relevant document based upon the phonetic version of the search term, d) selecting a translated document that represents the document identified in step c), translated into a second language, and f) returning, to the user, the translated document.

### FIELD OF THE INVENTION

This invention relates to a new multi-language search engine, for searching in collections of electronic documents, in particular where a document is present in several language versions.

### BACKGROUND

Immigrants often does not know the local language and therefore may have difficulties in finding useful information provided by the community and the local authorities such as information about healthcare, immigration services, work permits, etc. Today, immigration counselors and asylum support staff are overwhelmed by work involving providing advice regarding these issues, and guiding immigrants in contacts with local authorities.

It would be useful if this type of information could be provided to immigrants in a more convenient manner.

U.S. Pat. No. 7,984,034 provides a method for providing parallel language resources when searching the web. It provides a methods that includes the steps of identifying parallel resources (for example translations) and building a parallel resource map.

### SUMMARY OF THE INVENTION

For this reason is provided, in a first aspect of the invention, a computer implemented document retrieval method comprising the steps of: a) allowing a user to select a first language and a second language, b) allowing a user to input a search term in the first language, c) applying a phonetic algorithm to the search term, so that a phonetic version of the search term is obtained, d) using the output from step c) to perform a search in a collection of documents comprising a plurality of language versions (sub documents) of electronic text documents, and where said search identifies the most relevant sub document in the first language based on the phonetic version of the search term, e) selecting the sub document that represents the sub document identified in step d), translated into the second language, and f) returning, to the user, the sub document in the second language which was identified in step e).

The method according to the invention can suitably be implemented by a service that can be accessed by a piece of software executed on, or a web service accessed from, a handheld computer unit such as a smart phone. By using the service, a person can search for community information in either his native tongue or the local language and obtain a document in the other language. For example, if an immigrant with Arabic as his native tongue and who knows only the word NHS (for “National Health Service”, in the UK) in English but wants more information in Arabic about healthcare, he can search for “NHS” with the service and retrieve a document in Arabic about the NHS. The method corrects for misspellings by the user, which is an advantage since the user is perhaps using search terms which is not in his or her mother tongue.

The method and system also facilitates learning of the local language since an immigrant may have immediate and simultaneous access to a document in his native language and, in one embodiment of the invention, in the local language.

The documents and/or sub documents in the collection of documents can be arranged in a predefined logical structure. For example, the predefined logical structure can be such that every sub document is associated with at most one sub document in every other language. The predefined logical structure can also be such that the every sub document is associated with one sub document in every other language, represented in the collection of documents. Providing a predefined logical structure has the advantage of removing the steps of identifying, ranking and arranging translations of documents according to the prior art, in particular U.S. Pat. No. 7,984,034.

In one embodiment the sub document in the first language identified in step d) is also returned to the user. This has the advantage that the use can compare the two language versions side by side.

The documents can be identified with various methods. Step d) may comprises the step of ranking documents based on the presence, in the documents, of a term, the phonetic version of which, matches the phonetic version of the search term (Method 1).

Step d) may comprise the step of ranking documents based on the presence, in the documents, of a synonym to the phonetic version of the search term (Method 2).

Step d) may comprise the step of ranking documents based on the theme of the documents, where the theme is determined based on a statistical model (Method 3). The statistical model may determine the theme of the documents by i) identifying a number of keywords that are present in all or a plurality of documents, ii) clustering documents that share the same keywords to a large extent. The number of keywords can be from 100 to 1000.

Step d) can comprise all methods 1, 2 and 3 described above where each of the three methods contributes to the ranking. Each of the methods 1, 2 and 3 can be assigned a different weight.

The collection of electronic documents may be a predefined collection of electronic documents. The number of electronic documents can be less than 1000 000.

The collection of documents may comprise at least two documents, of which at least one is present in at least three languages. Alternatively, at least two documents are present in at least three languages.

The method can comprise the step of, prior to step a), carrying out indexing of the collection of electronic documents. The indexing step may include the use of a phonetic algorithm.

In a second aspect of the invention there is provided a system for retrieving electronic documents, said system comprising at least one computer, a predefined collection of electronic documents, an indexing engine, and a search engine, said system capable of carrying out the method described above.

In a third aspect of the invention there is provided an article comprising a machine-readable medium that stores executable instructions for searching for an electronic document in a collection of electronic documents, the executable instruction causing a machine to carry out the method described above.

### BRIEF DESCRIPTION OF DRAWINGS

FIG. 1 is a schematic overview of an example of a collection of electronic documents, provided as an example only.

FIG. 2 is a flowchart that illustrates the inventive method.

FIGS. 3-4 are schematic overviews of a system according to the invention.

FIG. 5 is a flowchart that illustrates the inventive method.

FIG. 6 is a schematic overview over a collection of electronic documents

### DETAILED DESCRIPTION

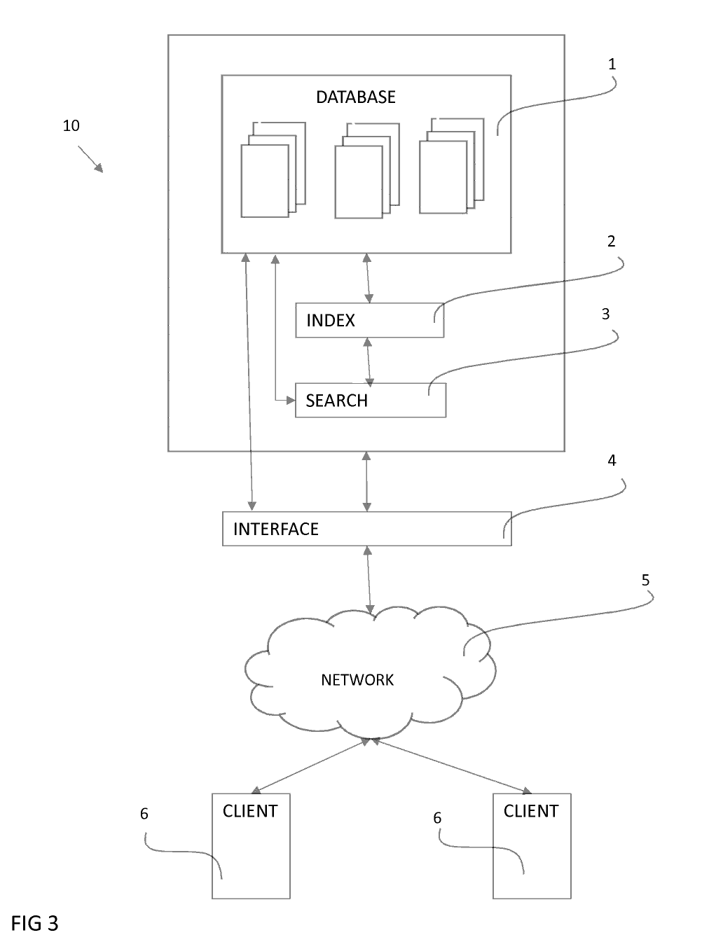

The invention comprises a system 10 (in FIG. 3) that is able to carry out the inventive method. The system 10 can be the basis for providing a computerized searching service where a user can search in a collection of electronic documents 1.

The collection of electronic documents 1 can comprise electronic documents or links to documents provided by third parties, for example government agencies such as healthcare providers, the police, employment agencies, etc. Preferably, the collection of documents comprises documents and not links to documents.

Each document is present in several language versions. The various language versions of a document is referred to as “sub documents” herein. Each sub document is associated with the other sub documents (language versions) so that when a sub document in a first language is identified by the system 10, the system 10 immediately has access to the document in the second language versions through a link or other kind of logical association.

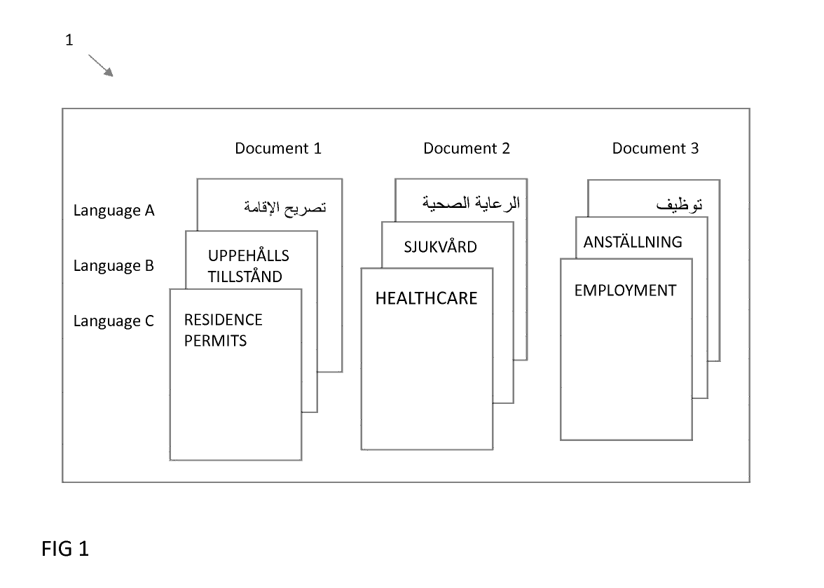

With reference to FIG. 1, the sub documents A, B and C of Document 1 are associated with each other. FIG. 1 shows a schematic collection of electronic documents 1 where each document exists in three language versions; an Arabic version (A), a Swedish version (B), and an English version (C). There are three documents, one about residence permits (Document 1), one about healthcare (Document 2) and one about employment issues (Document 3). In the same manner, the three language versions A, B and C of Documents 2 and 3 are associated with each other.

The logical associations may preferably be arranged such that each sub document in the collection of documents 1 is only associated with other language versions of the same document (see below).

The association enables the system 10, when it has identified a sub document in a first language, to select and return to the user a sub document in the second language (translation) by using a language selection previously made by the user.

With reference to FIG. 1, in reality it is likely that the number of documents is closer to several hundred, each document present in perhaps 5, 10 or 20 different language versions. The collection of electronic documents 1 is preferably maintained as a database 1 that can be accessed by the rest of the system 10.

The collection of electronic documents 1 is preferably a predefined collection of electronic documents. For example it can be a defined collection of documents that describe community services, such as healthcare, employment agencies etc. The host of the service curates the collection of electronic documents 1 and decides which community-related information should be included, and which new documents, if any, should be added to the collection 1.

This saves computing power, because such a predefined document collection is much faster to index than for example, the world wide web of the internet. This has the advantage that indexing does not have to be carried out in real time such as when indexing the internet. Instead, indexing can be carried out when use is low, for example during night time.

The collection of documents 1 preferably comprise text documents such as for example web pages (HTML documents), .pdf documents and word documents. The electronic documents are preferably digitally stored, for example on a server. The documents in the collection of documents contains at least some text.

The documents may be provided from the third parties in different manners. One method is to download the documents from web pages by downloading webpages in their entirety (“web scraping”) and extract the text for the documents from the web pages. Alternatively, the third parties may grant access to a database comprising the text documents from which the documents can be downloaded. The various language versions (sub documents) of the documents in the collection of documents may be provided from the third parties or may be generated as machine translations from one language sub document. Preferably the sub documents are added to the collection of documents in accordance with the predefined logical structure (see below).

The number of electronic documents in the collection of documents 1 can be less than 10000000, preferably less than 100 000, more preferably less than 10 000 and most preferably less than 1 000.

At least two documents in the collection of electronic documents 1 is present in at least two language versions. Preferably all documents, or almost all documents are present in more than one language, such that all or almost all documents in the collection of electronic documents 1 are present in 2, 3, 4, 5 or more languages. Most preferably there are at least two documents and at least one, or preferably at least two, of these documents is present in at least three language versions.

For the avoidance of doubt it should be noted that all languages represented in the electronic documents in the collection of documents 1 can be the first language (search language) and that all languages represented in the collection of documents 1 can be the second language. When it is referred to a “translation” or a “translated document” herein it does not infer a direction of translation, such that translation from language A to language B has occurred. It may be that translation has actually been carried out in the opposite direction, from language B to language A. The sub documents of a document herein has the same text but in various languages.

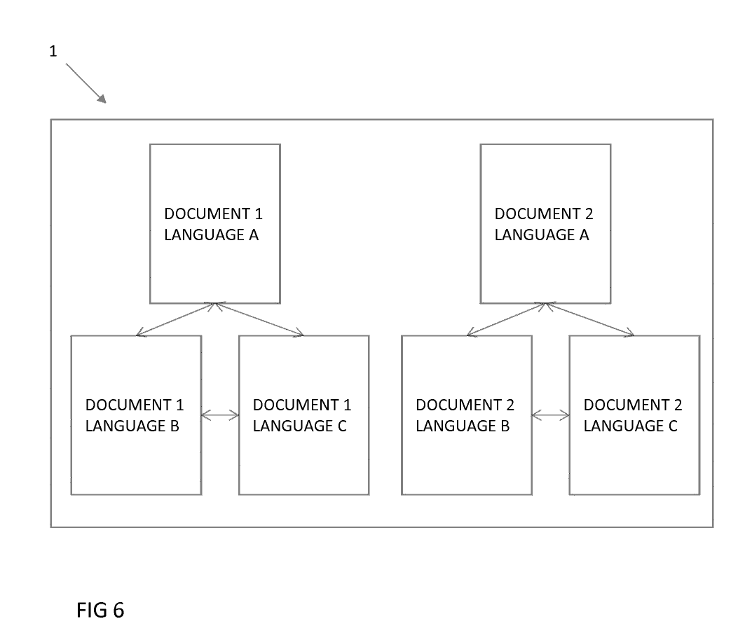

The collection of documents 1 may comprise logical associations between the different languages versions of a document in accordance with a predefined logical structure. The pre-defined logical structure is preferably such that, when the system has access to a sub document document, it has immediate access to the sub documents of the document, and to those documents only. The selection and returning of the appropriate language version is done by applying the language selection made by the user. This may be achieved by a logical structure in which every sub document is associated with at most one sub document in every other language represented in the database. For example, if the languages represented in collection of documents 1 are English, German and Arabic, a sub document in English may only be associated with one sub document in German and one sub document in Arabic. An example of such a predefined logical structure is shown in FIG. 6. The arrows in FIG. 6 indicate logical associations.

If a sub document A contains a hypertext link to a sub document B which contains a hypertext link to a sub document C, sub documents A and C does have a logical association according to the invention.

The predefined logical structure may implemented in a database in which every sub document is associated with only one sub or at most one document in every other language, namely the translations of that document to the other languages. Table 1 is schematic example of such a database.

TABLE 1

| | English version | German version | Arabic version |
|---|---|---|---|
| Document 1 | Sub document | Sub document ID #4 | Sub document ID #7 |
| Residence | ID #1 | | |
| permits | | | |
| Document 2 | Sub document | Sub document ID #5 | Sub document ID #8 |
| Healthcare | ID #2 | | |
| Document 3 | Sub document | Sub document ID #6 | Sub document ID #9 |
| Employment | ID #3 | | |

The predefined logical structure may be a tree structure, preferably a tree structure with two levels, where the sub document in the first language is in the first level of the tree structure and the sub documents in the other languages, including a second language, is in the second level of the tree structure.

The languages can be chosen depending on the intended use of the collection of electronic documents 1. Conveniently, the languages are chosen to support immigration. At least one language is then suitable a local language and at least one language of the native language of a group of immigrants that is supported by the service that implements the system and or/method of the invention. Thus, if the local language is Swedish, the other languages could be for example Arabic and Somali.

The method provides a convenient way for a user to search the collection of electronic documents 1 in the language of his choice and to retrieve the document in the, possibly different, language of his choice. The first step in the inventive method is entering of the search term by the user in step 101. The user can for example access the service that implements the inventive method through an app or web browser in his or her smart phone as described below. The user enters the search term in the first language in step 101. Conveniently, this is done on a client 6 that communicates with the system 10 (see below). The first language and second language are different languages and can be any one of the languages of the electronic documents in the collection of documents 1 which can be any written language in the world, although preferably it is a written language for which presently existing document indexing tools and phonetic algorithm works.

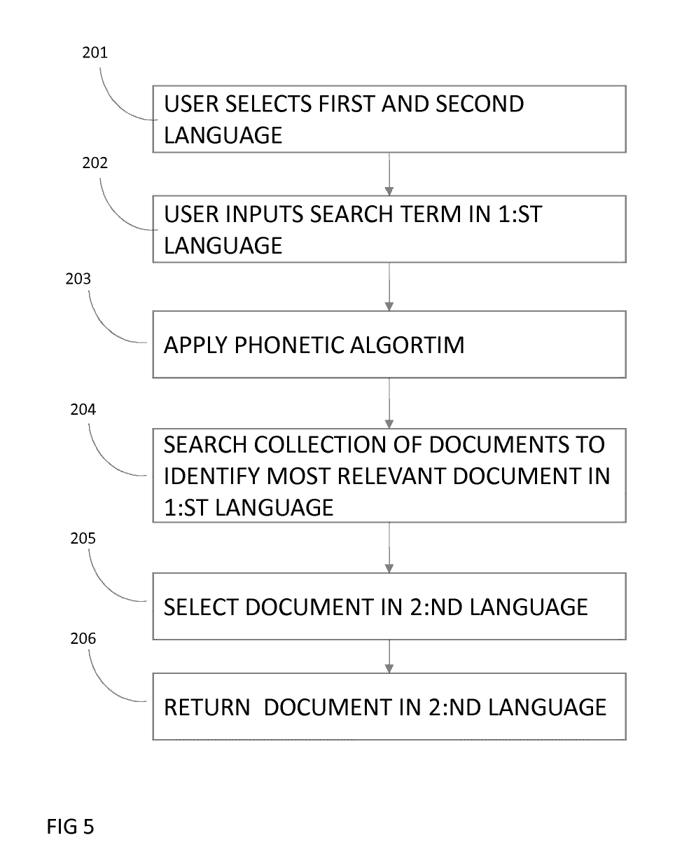

The user may be prompted, the first time he uses the service, to choose languages that then becomes the preset default first and second languages. However, suitably, the user may change the language settings at any time. The user may for example want to search for information in the local language by inputting a search term in his native language. Alternatively, he may want to search for information in his native language by inputting a search term in the local language. Thus step 101 is preceded by the user selecting a first and second language as discussed below and in relation to FIG. 5.

The system then, in step 102, applies a phonetic algorithm to the search term. A phonetic algorithm is an algorithm for indexing of words by their pronunciation. By way of example, a simple part of a phonetic algorithm for the English language is to always replace Z with S, and replace PH with F.

The use of a phonetic algorithm has the advantage that misspellings by the user (who may be not using his or her native language) does not reflect on the quality of the search. Phonetic algorithms are well known and can be chosen depending on the languages in the documents of collection of electronic documents 1. For example, when the language is English or Swedish, the phonetic algorithm may be Metaphone, Double Metaphone or Soundex and when the language is German the algorithm may be Kölner Phonetik. The use of a phonetic algorithm is particularly useful since the user is likely to carry out searches in a language that is not his native language. Thus, misspellings are avoided. If for example, the user wants to search for sick transport and enters “AMBJULANCE” the search engine will return documents that contain “AMBULANCE”.

In step 103 the system uses the phonetic version of the search term to identify the most relevant sub document in the first language. This is carried out by search engine 3 and index 2 in FIG. 3.

The search step 103 can be carried out using several different search methods, or combinations of search methods. Preferably, several different methods can be used and combined for providing an optimal search result.

One such method is to identify documents based on the presence of the (phonetic version of) the search term. The search term may be individual words or phrases that consists of two words or more. Preferably stemming is used to take into account different forms of the word.

However, more advanced methods may also be used. Since the user may not have command of the full vocabulary a useful method to include in the search method is to expand the search to synonyms of the search term. Thus, documents that contain synonyms or keywords that match the input term can also be identified in the search. The index 2 may contain a pre-defined list of synonyms for search terms. For example, search for SICK TRANPORT returns not only documents that refer to SICK TRANSPORT but also to documents that contain the word AMBULANCE.

A yet more refined method that can be implemented with the inventive method is the determination of the theme of each document. The theme is summary of the content of the documents. Documents can for example be indexed such that each document is provided with keywords as metadata.

Also, by using statistical methods, a number of keywords (for example 100 to 1000 predetermined different keywords, more preferably 200 to 500 keywords) that occur in the collection of electronic documents 1 can be identified in each electronic document. Documents can be clustered according to the presence of a keyword that is present in all documents.

In that case they are clustered based on the frequency of the keyword. The documents can also be clustered based on the presence of a keyword that is present in a plurality (i.e. at least two) of documents. Thereby documents that share the same keywords will be clustered together. Documents that comprise similar distributions of such keywords are grouped together, for instance using conventional clustering techniques such as K-means clustering, as being about the same theme. As an illustrative example, broad themes could be healthcare, schools, work permits, and employment. However, more narrow themes can be used as well. For example, one theme could relate do documents that describe how to apply for a work permit.

Preferably the themes of the electronic documents are automatically determined. The content of the electronic document can be analyzed to obtain a “document signature”. The document signature can be obtained by methods known in the art. For example US 2011/00993331 discloses a method for analyzing content of a web page comprising using weighted page term vectors. The document signature can depend on, among other parameters, the frequency of the term in the document or on the web page. Not all terms in the electronic document are selected for creating the document signature. Terms may be selected based on, for example, term frequency-inverse document frequency (tf.idf) scores.

Thus, the method can comprise the additional step 100 of initially indexing the collection of electronic documents 1 to create an index 2 to be used by search engine 3 with any of the methods described above. Indexing will result in an index capable of being searched with for example one methods described above. Examples of methods that can be used during indexing includes parsing, stemming, application of phonetic algorithms and calculation of term vectors and tf.idf scores.

When themes are used, the themes can be determined for one language version of each document only, in order to save computing power and to minimize management of the index. Thus indexing of the collection of documents 1 with the use of themes can be used for one language version only (theme indexing language). The metadata that describes the theme for each document can however be accessed by the search index even if a search is carried out in a first language that is not the theme indexing language. However, in a preferred embodiment, indexing is carried out in all languages. Thus an index is created for each language represented in the collection of documents. Thereby, any language present in the collection of documents can be the first language (the “search language”).

The system 10 that implements the method then identifies, in step 103, at least one document for presentation to the user.

Preferably, the documents in the collection of electronic documents 1 are ranked based on relevance and the document with the highest ranking is identified in step 103. Alternatively a subset of the highest ranking documents may be selected and translations thereof may be presented to the user in steps 103-105, who may then decide to read the document he or she prefers.

In its most fundamental version of the invention, the so identified sub document (or documents when a ranking is presented to the user) is not presented to the user (although this can be done, see below). Instead, a version (sub document) of the document in a second language is selected in step 104 and is presented to the user in step 105, by applying the selection of second language that the user has carried out previously. Preferably the sub document in the second language is displayed on the display on the client 6 allowing the user to read the sub document. This may be a pre-selected language that the user selects when first accessing the service. Alternatively the user may choose the second language from a list of languages, the list comprising at least two languages, more preferably three languages, that the document is present in. With reference to FIG. 1, and as an example; if the first language is A, the second language may be B or C. Step 104 can preferably be carried out by the system by using the logical association from the document in the first language to the document in the second language. This is preferably made possible by using the predefined logical structure of the collection of documents 1.

At least one part of the electronic document may be returned to the user, such that at least some words from the document which is the best hit is returned and displayed to the user. The reply may comprise a link to the document. Conveniently a list of hits is returned to the user, the best hit being at the top of the list. Thus a list of hits is displayed on the screen on the device. The user can access the documents from the list of hits. When sub documents in both first and second languages are returned to the user, both documents can be shown to the user, for example on a split screen. Thus the display of client 6 may be divided into at least two windows where each window displays one language version of the document.

In one embodiment the sub document in the first language is also shown to the user. This facilitates communication when the user needs to discuss something with, for example, an immigrant counselor, because then both parties can have access to the document in his (or her) language.

The invention also relates to a system 10 for carrying out the method. The system comprises collection of electronic documents 1, indexing engine 2 and search engine 3. The system may also comprise an interface 4. A schematic overview of the system is seen in FIG. 3.

The documents in the collection of electronic documents 1 are indexed by indexing engine 2 which also comprises the index which is queried by the search engine 3. The indexing engine 2 carries out parsing and indexing of the electronic documents and applies the phonetic algorithm on the documents in the collection of electronic documents 1 and produces an index to be searched by the search engine 3. This is carried out once when the collection of electronic documents 1 is established but also if and when new electronic documents are added to the collection 1.

The method is intended to be implemented by software. The collection of electronic documents 1 may for example be a database run on a server, for example a RavenDB database. The open source search engines Solr or DataparkSearch may be used for the indexing and search step (step 103) implemented by indexing engine 2 and search engine 3. However, the methods described herein can be implemented in any suitable computing or processing environment implemented by software, hardware or both. The method may be implemented by software stored in a memory such as a solid state memory or a hard drive and executed by a processor.

Preferably the system 10 is hosted on one or more servers that can be accessed through a communication network 5 such as the internet by a client 6. The client 6 is a computing device with a screen and input means such as for example a keyboard or a touch sensitive screen. Examples of computing devices includes personal computers, tablet computers and smart phones.

Electronic documents can be accessed by the client 6 trough search engine 3 or directly through interface 4.

Preferably the service can be accessed through a smart phone, for example through an app or through a web browser. The user can input search terms using the input means and the display of client 6. The input term is then sent to system 10 through network 5 and the system 10 carries out steps 101, 102, 103, 104 and 105 of the method and then sends the reply to the client 6, so that the user can read the reply, including hit list and document, on the screen on the device.

The system may comprise an interface 4. The interface sends and receives information to and from the client and to and from search engine 3. The interface can for example be a front end web server, for example a HTML5 server, which provides a very efficient way to provide a service that can be accessed through a web browser such as Safari or Chrome on a smart phone. The interface 4 can, for example, also be the interface for an app that is run on the client 6, such that the app communicates with the interface 4. Although the interface 4 may be an important for the access to the service for the client 6, it may not necessary form a part of system 10.

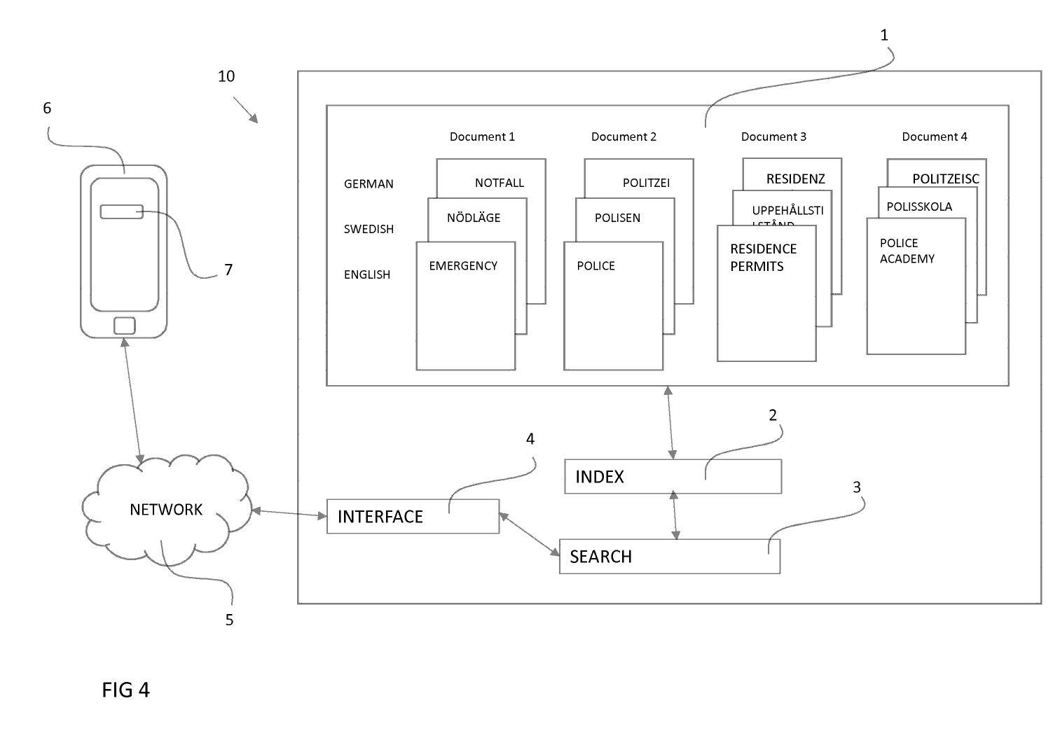

In the following is an example of how the invention can be used. Table 2 shows an example of a schematic index of a collection four documents (Documents 1-4). The documents are present in three language version in the collection of electronic documents 1, as can be seen in FIG. 4., an English version, a Swedish version and a German version.

TABLE 2

| Document 1 | Document 2 | Document 3 | Document 4 |
|---|---|---|---|
| police | police | residence permit | police |
| emergency | police | work permit | police |
| ambulance | police | citizenship | police |
| fire | emergency | | admission |
| call 112 | call 112 | | training |

Document 1 is a home page about emergency services and contains the word “ambulance” and “fire” and “police” (three times) as well as the European emergency number 112.

Document 2 is a home page from the local police office and contains the word “police” three times as well as the word “emergency” and the emergency number 112.

Document 3 is a home page from the local migration office and does not contain the word “police”.

Document 4 is a home page of the local police academy about admission to local police academy and contains the word “police” three times.

During indexing, the phonetic algorithm has been applied and the words police is coded as “polis”, because “ce” is replaced with S by this particular phonetic algorithm. For the sake of clarity, the index is shown before application of the phonetic algorithm.

In this particular example, indexing will be carried out on basis of the presence of the terms and also by the theme of the document. Documents 1 and 2 will be grouped together as sharing the same theme in the index because they share three keywords (“police”, “emergency” and “call 112”). As discussed above, this can be carried out with statistical methods. Documents 1, 2 and 4 will be indexed as containing the word “police” (once for Document 1 and three times for Document 2 and 4, respectively).

In this example, a person who does not have English as his native language is in an English speaking country. He needs contact information to the local police. He takes out his client 6, for example a smart phone, and accesses a service through a web browser on his smart phone, the service implementing the method according to the invention. Thus, in this case, the interface 4 is a web server that enables the display of a web page in the display of the client 6. The web page has an input box 7 where the user can input the search term.

He types the word “poliz” (misspelling of “police”) in a search box 7 on the web page, and chooses English as the search language. Thus, in this example, English is the first language.

In this case he wants to carry out the search in English, but in addition he wants information in his native language (which happens to be Swedish). He therefore selects Swedish as his second language.

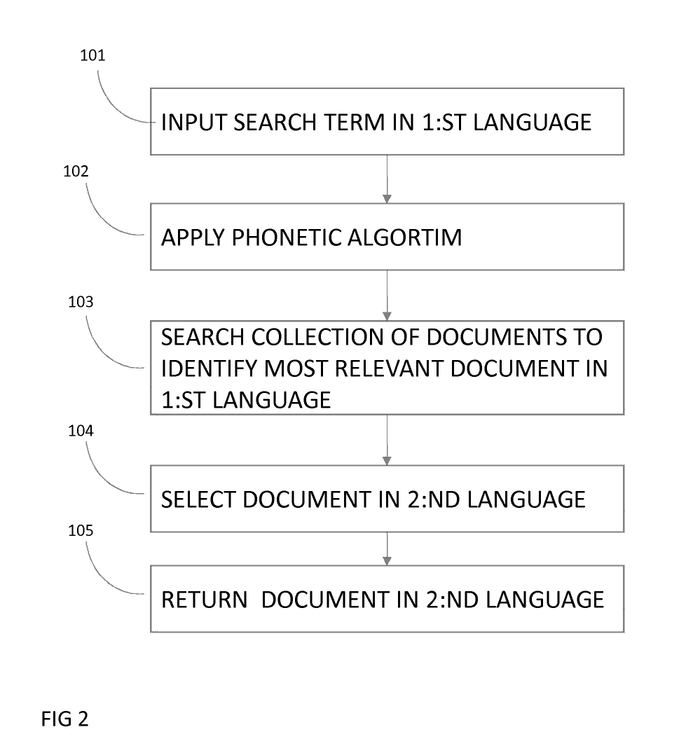

The client 6 is in contact with the interface 4 which in this case is a web server 4 through network 5 which in turn sends the query to the search engine 3 (step 101 in FIG. 2). The search engine 3 applies the phonetic algorithm to the query by replacing the Z in poliz with an S. Thus, the search engine 3 will search for documents that have the world “polis” (Step 102 in FIG. 2).

Step 103 is, in this example, carried out as follows. In the index of the collection of electronic documents 1 there are three sub documents in English that contain the word phonetic equivalent of “police” (Documents 1, 2 and 4) and one that does not contain the word police” (Document 3). In addition, documents 2 and 4 each include the word “police” the same number of times (three times). However, Document 2 shares several keywords with document 1 (“emergency” and “call 112”), whereas document 4, which is about admission to the local police academy, does not share any keywords with document 1. Therefore, in the choice between document 2 and 4 (which both has the keyword the same number of times), document 2 is ranked over document 4 because it is grouped together with another similar document (Document 1), where the similarity is based on the number of shared keywords. Therefore, in step 103, Document 2 is identified in this example. Thus, in this case, the documents were ranked based on the presence, in the document, of a term, the phonetic version of which, matches the phonetic version of the search term in the documents as well as the theme of the documents.

In the next step 104 the system 10 selects the Swedish version of document 2 since Swedish was chosen as the second language. In step 105 the Swedish version of Document 2 is returned to the interface 4 which displays Document 2 in Swedish in the web browser of client 6.

FIG. 5 shows the method in more detail. Here it is shown how, in step 201, the user first selects a first and second language. The first language is the language of the search and the second language is the language in which the document is to be returned in. In step 202 the user inputs the search term in the first language. In step 203 the system applies the phonetic algorithm and in step 204 the system searches the collection of documents. The search is carried out in the first language sub documents. The most relevant document is identified. In step 205 the system applies the language selection by the user and selects the sub document in the second language. This is done by the system using the predefined logical structure as described above and shown in FIG. 6. The system need only apply the language selection and follow the logical association to the sub document in the second language. For example the system may query a database such as shown in Table 1 and apply the language selection previously made by the user. In step 206 the sub document in the second language is returned to the user.

FIG. 6 is a more detailed figure of a collection of electronic documents 1 that shows a schematic overview of a predefined logical structure. The collection of documents in this example contains two different documents, document 1 and document 2. Each document is present in three language versions (translations/sub documents), language versions A, B and C. The arrows indicate logical associations. The sub documents are not associated to any other documents in the collection of documents. Thus when the system has identified the most relevant sub document in the first language, which may be language A, B or C, the system applies the language selection and selects the sub document in the second language. If the user has selected B as first language and C as second language, the search is carried out in language B, and sub document in language C is displayed to the user.

Signals for implementing the method may be transmitted through the internet, through a wire network such as Ethernet, or through a wireless net such as for example a Wi-Fi network or a wireless broadband network.

The system and/or method may be implemented at least in part via a computer program product, i.e. a computer product for execution by a data processing apparatus, e.g. a programmable processor on one or more computers. A computer program may be stored on a storage medium (e.g. a solid state memory, a hard disk, or a CD-ROM).

While the invention has been described with reference to specific exemplary embodiments, the description is in general only intended to illustrate the inventive concept and should not be taken as limiting the scope of the invention. The invention is generally defined by the claims.

1. A computer implemented document retrieval method comprising the steps of:
a) allowing a user to select a first language and a second language,
b) allowing a user to input a search term in the first language,
c) applying a phonetic algorithm,
d) using the output from step c) to perform a search in a collection of documents comprising a plurality of language versions (sub documents) of electronic text documents, and where said search identifies the most relevant sub document in the first language based on the phonetic version of the search term,
e) selecting the sub document that represents the sub document identified in step d), translated into the second language,
f) returning, to the user, the sub document in the second language which was identified in step e)
wherein step c) is carried out by applying a phonetic algorithm to the search term, so that a phonetic version of the search term is obtained and in that the collection of documents is arranged such that a sub document is associated with at most one sub document in every other language.

2. (canceled)

3. The method of claim 1 where, in addition, the sub document in the first language identified in step d) is returned to the user.

4. The method of claim 1 where step d) comprises the step of ranking documents based on the presence, in the documents, of a term, the phonetic version of which, matches the phonetic version of the search term.

5. The method claim 1 where step d) compromises the step of ranking documents based on the presence, in the documents, of a synonym to the phonetic version of the search term.

6. The method of claim 1 where step d) comprises the step of ranking documents based on the theme of the documents, where the theme is determined based on a statistical model.

7. The method of claim 6 where the statistical model determines the theme of the documents by i) identifying a number of keywords that are present in all or a plurality of documents, ii) clustering documents that share the same keywords to a large extent.

8. The method of claim 7 where the number of keywords is from 100 to 1000.

9. The method of claim 1 where step c) comprises the step of ranking documents
i) based on the presence, in the documents, of a term, the phonetic version of which, matches the phonetic version of the search term,
ii) based on the presence, in the documents, of a synonym to the phonetic version of the search term, and
iii) based on the theme of the documents, where the theme is determined based on a statistical model, and where each of i), ii) and iii) contribute to the ranking.

10. The method of claim 9 where each of i), ii) and iii) are assigned a different weight.

11. The method of claim 1 where the collection of electronic documents is a predefined collection of electronic documents.

12. The method of claim 11 where the number of documents is less than 1,000,000.

13. The method according to claim 1 where the collection of documents comprises at least two documents, of which at least one is present in at least three languages.

14. The method according to claim 1 comprising the additional step, of, prior to step a), carrying out indexing of the collection of electronic documents.

15. The method according to claim 14 where the indexing step includes the use of a phonetic algorithm.

16. A system for retrieving electronic documents, said system comprising at least one computer, a predefined collection of electronic documents comprising a plurality of language versions (sub documents) of electronic text documents, an indexing engine, and a search engine, said system configured to:
a) allow a user to select a first language and a second language,
b) allow a user to input a search term in the first language,
c) apply a phonetic algorithm,
d) use the output from c) to perform a search in the predefined collection of electronic documents and where said search identifies the most relevant sub document in the first language based on the phonetic version of the search term,
e) select the sub document that represents the sub document identified in step d), translated into the second language,
f) return, to the user, the sub document in the second language which was identified in e),
wherein c) is carried out by applying a phonetic algorithm to the search term, so that a phonetic version of the search term is obtained and the collection of documents is arranged such that a sub document is associated with at most one sub document in every other language.

17. An article comprising a non-transitory machine-readable medium that stores executable instructions for searching for an electronic document in a collection of electronic documents comprising a plurality of language versions (sub documents) of electronic text documents, the executable instructions causing a machine to:
a) allow a user to select a first language and a second language,
b) allow a user to input a search term in the first language,
c) apply a phonetic algorithm,
d) use the output from c) to perform a search in the predefined collection of electronic documents and where said search identifies the most relevant sub document in the first language based on the phonetic version of the search term,
e) select the sub document that represents the sub document identified in step d), translated into the second language,
f) return, to the user, the sub document in the second language which was identified in e),
wherein c) is carried out by applying a phonetic algorithm to the search term, so that a phonetic version of the search term is obtained and the collection of documents is arranged such that a sub document is associated with at most one sub document in every other language.
